(19) United States
(12) Patent Application Publication
(10) Pub. No.: US 2004/0152360 A1
(43) Pub. Date: Aug. 5, 2004

(54) Power connector having integral easy-access blade fuse receptacle

(76) Inventors: Shaun L. Harris, McKinney, TX (US); Steve Belson, Plano, TX (US); Eric C. Peterson, McKinney, TX (US)

Correspondence Address: HEWLETT-PACKARD COMPANY, Intellectual Property Administration, P. O. Box 272400, Fort Collins, CO, 80527-2400, US

(21) Appl. No.: 10/355,420

(22) Filed: Jan. 31, 2003

(51) Int. Cl. H01R 13/68

(52) U.S. Cl. 439/621

(57) ABSTRACT

A male power connector features an integral, easy-access blade fuse receptacle. The connector includes a nonconductive housing, two pins extending from a first side of the housing for insertion into a power supplying female socket, two flexible conductors extending from a second side of the housing for supplying power to an electrical system, and two openings in the housing for receiving the blades of a blade-style fuse. The openings are configured to prevent the body of the fuse from entering the housing so that the fuse may be easily inserted and removed by hand. A first conductive path is provided between one of the pins and one of the conductors; but a second conductive path between the other pin and the other conductor is interrupted between the two openings. Insertion of the blade fuse completes the second conductive path.

### FIELD OF THE INVENTION

This invention relates generally to fuse holders and to power connectors.

### BACKGROUND

It is desirable to locate blade-style fuses conveniently in computer-related applications. It is also desirable in such applications to be able to insert and remove blade-style fuses easily by hand. While numerous blade fuse receptacles have been devised for automotive applications, the automotive receptacles emphasis design goals that contradict convenience of location and ease of removal and insertion.

For example, U.S. Pat. No. 6,109,973 (“Gronowicz”) discloses a fuse receptacle contained inside an in-line wiring harness junction. In Gronowicz, the entire body of the fuse is inserted into the receptacle so that the fuse body may act as a wedge for retaining an adjacent female terminal inside the receptacle. When the harness is joined, the fuse is completely hidden inside the junction housing. The Gronowicz fuse would be difficult if not impossible to remove by hand. Moreover, its location would be considered inconvenient for computer applications.

By way of further example, U.S. Pat. No. 6,146,206 (“Konno”) discloses a connector plug soldered to a circuit board. The connector plug has a single mating side for receiving both a connector socket and a blade fuse. In Konno, the connector plug is specifically designed to make removal of the blade fuse difficult. The fuse body is inserted almost entirely into the connector plug housing, and is retained therein by the housing of the connector socket once the plug and socket are joined. As in Gronowicz, the fuse is hidden once the plug and socket are joined, and would be impossible to remove without disconnecting the socket from the plug.

### SUMMARY OF THE INVENTION

A power connector according to a preferred embodiment of the invention features an integral, easy-access blade fuse receptacle. The blade fuse is conveniently located and may easily be inserted and removed by hand. Such an embodiment includes a nonconductive housing, two pins extending from a first side of the housing for insertion into a power supplying female socket, two flexible conductors extending from a second side of the housing for supplying power to an electrical system, and two openings in the housing for receiving the blades of a blade-style fuse. The openings are configured to prevent the body of the fuse from entering the housing so that the fuse may be easily inserted and removed by hand. A first conductive path is provided between one of the pins and one of the conductors; but a second conductive path between the other pin and the other conductor is interrupted between the two openings. Insertion of the blade fuse completes the second conductive path.

### BRIEF DESCRIPTION OF THE DRAWINGS

FIG. 1 is an oblique front view of a power connector according to a first preferred embodiment of the invention.

FIG. 2 is an oblique rear view of a power connector according to a second preferred embodiment of the invention.

FIG. 3 is an oblique rear view of a power connector according to a third preferred embodiment of the invention.

FIG. 4 is an oblique rear view of a power connector according to a fourth preferred embodiment of the invention.

FIGS. 5 and 6 are cross-sectional views illustrating various ways to construct the embodiments of FIGS. 1 and 2.

FIGS. 7-9 are cross-sectional views illustrating various ways to construct the embodiments of FIGS. 3 and 4.

### DETAILED DESCRIPTION OF THE PREFERRED EMBODIMENTS

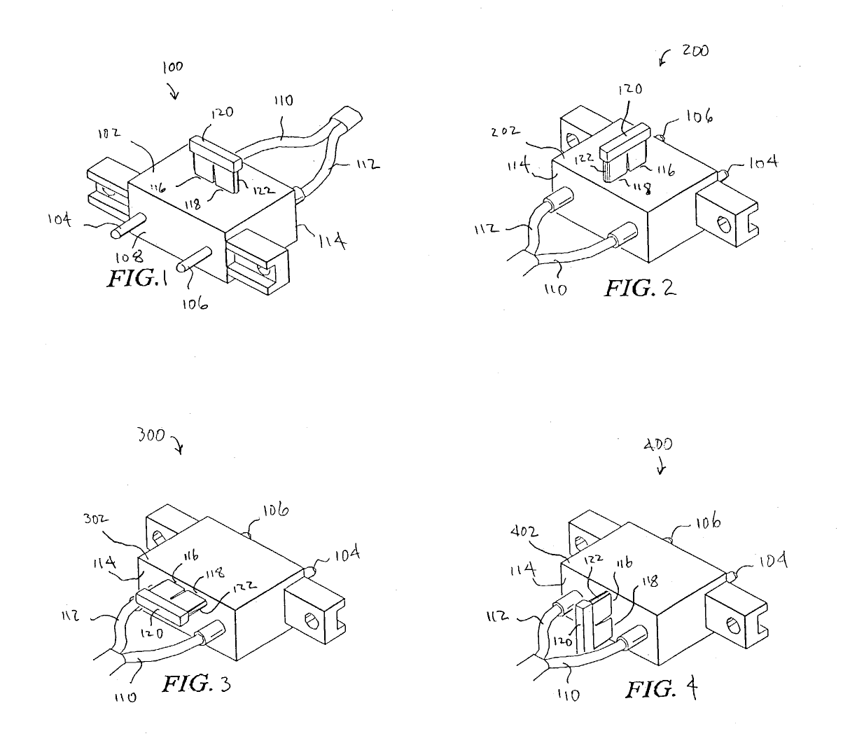

FIGS. 1-4 illustrate various preferred embodiments of a power connector 100, 200, 300, 400 having an integral easy-access blade fuse receptacle. The assemblies shown may be constructed, for example, via injection molding or other known processes utilizing nonconductive plastic resins to create nonconductive housings 102, 202, 302, 402. In each embodiment, conductive pins 104, 106 extend from side 108 of the housing. Pins 104, 106 should have appropriate spacing and length so that they may be inserted into a corresponding power supply female socket (not shown). Flexible conductors 110, 112 extend from side 114 of the housing. Conductors 110, 112 should have appropriate length, flexibility and gauge to supply power to an electrical system such as a computer subsystem located remotely from the connector.

Each embodiment features openings 116, 118 in the housing for receiving the blades of a blade-style fuse 120. Openings 116, 118 are configured to prevent the body 122 of fuse 120 from entering the housing. Prevention of the fuse body from entering the housing may be accomplished, for example, by forming openings 116, 118 sufficiently narrowly that fuse body 122 cannot fit inside them. Alternatively, the portion of the housing that separates openings 116, 118 from one another may be sufficient to block entry of fuse body 122 into the housing. Because the fuse body does not enter the housing, the fuse body may readily be grasped between the fingers. Thus, the fuse is easily inserted and removed by hand.

In embodiments 100, 200, openings 116, 118 are located on a side of the housing not populated by pins 104, 106 or by conductors 110, 112. In embodiments 300, 400, openings 116, 118 are located on the same side of the housing as are conductors 110, 112.

In each of the embodiments shown, side 108 from which pins 104, 106 extend is a front side of the housing and side 114 from which conductors 110, 112 extend is a back side. In alternative embodiments, conductors 110, 112 may exit from other sides of the housing without deviating from the scope of the invention.

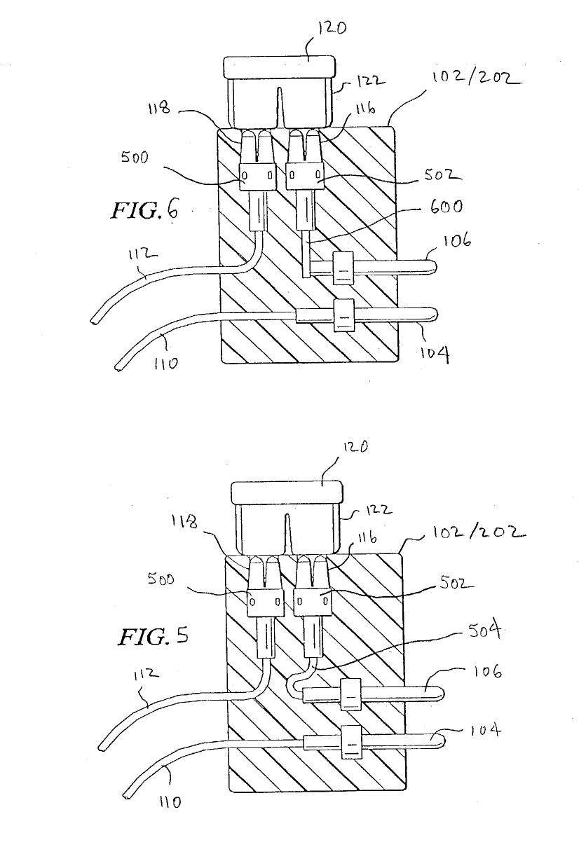

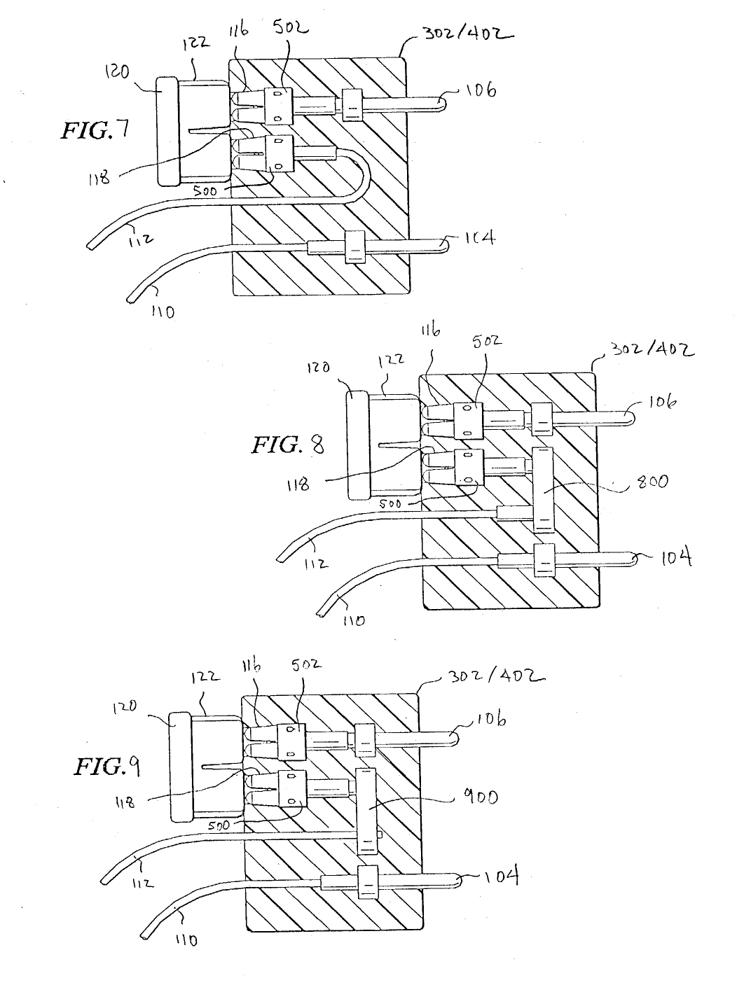

FIGS. 5 and 6 illustrate various ways in which embodiments 100, 200 may be constructed internally. FIGS. 7, 8 and 9 illustrate various ways in which embodiments 300, 400 may be constructed internally. In all embodiments: a conductive path is provided between pin 104 and conductor 110; a conductive path is provided between pin 106 and female blade terminal 502; and a conductive path is provided between female blade terminal 500 and conductor 112. Insertion of blade fuse 120 into openings 116, 118 completes a conductive path from pin 106 to conductor 112.

In FIG. 5, a wire 504 is used to create the conductive path between pin 106 and female blade terminal 502. In FIG. 6, a right-angle bus bar 600 is used to provide the same conductive path. In FIGS. 7-9, that connection is made directly. All connections may be made, for example, by soldering or crimping.

In FIG. 7, conductor 112 is bent to make a 180 degree transition from female blade terminal 500 to its exit point from the housing. In FIG. 8, a 180 degree bus bar 800 is used for this purpose. In FIG. 9, a right angle bus bar 900 is used for the same purpose.

While the invention has been described in detail in relation to various preferred embodiments thereof, the described embodiment has been presented by way of example and not by way of limitation. It will be understood by those skilled in the art that changes may be made in the form and details of the described embodiments without deviating from the spirit and scope of the invention as defined by the appended claims.

What is claimed is:

1. A power connector, comprising:
a nonconductive housing;
first and second pins extending from a first side of the housing for insertion into a power supplying female socket;
first and second flexible conductors extending from a second side of the housing for supplying power to an electrical system;
first and second openings in the housing for receiving the blades of a blade-style fuse but configured to prevent the body of the fuse from entering the housing;
a conductive path between the first pin and the first conductor;
a conductive path between the second pin and a female blade terminal in the first opening; and
a conductive path between the second conductor and a female blade terminal in the second opening.

2. The male power connector of claim 1, wherein:
the first side of the housing is a front side and the second side of the housing is a back side.

3. The male power connector of claim 1, wherein:
the first and second openings are sufficiently narrow to prevent the body of the fuse from entering the housing.

4. The male power connector of claim 1, wherein:
a portion of the housing between the first and second openings prevents the body of the fuse from entering the housing.

5. The male power connector of claim 1, wherein:
the first and second openings are located on the second side of the housing.

6. The male power connector of claim 5, wherein:
the conductive path between the second conductor and the female blade terminal in the second opening includes a bus bar.

7. The male power connector of claim 1, wherein:
the first and second openings are located on a third side of the housing.
